(19) United States
(12) Patent Application Publication
(10) Pub. No.: US 2004/0134695 A1
(43) Pub. Date: Jul. 15, 2004

(54) Drive system for a motor vehicle

(76) Inventors: Frank Blome, Reichling (DE); Ullrich Masberg, Rosrath (DE); Jean-Pierre Nouailles, Castel Ferrus (FR)

Correspondence Address: Stephen M. De Klerk, BLAKELY, SOKOLOFF, TAYLOR & ZAFMAN LLP, Seventh Floor, 12400 Wilshire Boulevard, Los Angeles, CA, 90025, US

(21) Appl. No.: 10/719,491

(22) Filed: Nov. 21, 2003

(30) Foreign Application Priority Data
Nov. 21, 2002 (EP) EP 02 026 017.0

(51) Int. Cl. B60K 1/00

(52) U.S. Cl. 180/65.2

(57) ABSTRACT

A drive system of a motor vehicle comprising a combustion engine with a crankshaft, an electric polyphase machine and a polyphase power electronics unit for the electric machine. Said electric machine is designed as a starter, generator, or starter-generator, and is seated on the crankshaft of the combustion engine or an extension of the crankshaft. Said power electronics unit is located at the combustion engine and axially and radially to the electric machine. The electric machine and the power electronics unit are electrically connected by means of rigid electric lines.

### CROSS-REFERENCE TO RELATED APPLICATIONS

The present patent application claims priority from European Patent Application No. EP 02 026 017.0, filed on Nov. 21, 2002.

### BACKGROUND OF THE INVENTION

1). Field of the Invention

The invention concerns a drive system for a motor vehicle with a combustion engine and an electric machine located on the crankshaft of the combustion engine, which is designed as a starter, generator or starter-generator.

2). Discussion of Related Art

A drive system of this type with a crankshaft starter-generator is known from WO97/08456, for example. The book edited by A. Krappel: Crankshaft Starter-Generator—Basis for Future Vehicle Concept, 1^{st} edition, 1999, and in particular the article from B. Hoffmann: “ISAD Technology: Compact Top Performance in the Crankshaft Starter-Generator”, pages 6-23, reveals drive systems with crankshaft starter-generators.

The operation of such electric crankshaft machines generally requires a power electronics unit able to generate alternate voltages with a random frequency, phase and amplitude, i.e., able to create a so-called current inverter, for example. If the machine is a polyphase machine, the power electronics unit supplies the individual phases of the motor operation with voltages having a frequency, phase and amplitude selected in order to generate a suitable frequency creating a leading rotary field. In the case of a synchronous machine, it suffices to align the induced alternate voltages of the generator. The power electronics unit then only needs to operate as a voltage-controlled valve (in the nature of a diode). In the case of an asynchronous machine, on the other hand, a suitable (lagging) rotary field could be created in the generator area. This is done by generating voltages with a frequency and, if necessary, phase and amplitude suitable for the power electronics unit. Such a current inverter generally comprises power semi-conductor switches and one or more capacitors. The power semi-conductors are connected and disconnected in phase, i.e., plus-to-plus and minus-to-minus, with a high clock frequency and, for example, pulse-width modulation following a sine-weighted average. Based upon the low-pass effect of the inductance of the electric machine, the pulsed voltage sample creates by approximation sinusoidal currents having the desired frequency, amplitude and phase.

Following the current state of the art, the power electronics unit is housed in a basically cuboid enclosure attached inside the motor area of the motor vehicle on the vehicle frame. The power electronics unit is electrically connected with the electric machine by means of a flexible cable, e.g., bunched conductor cable, allowing for a relative movement between the electric machine, which rests on the crankshaft, and the vehicle frame. FIGS. 5 and 6 of said article of B. Hoffman published by Krappel show such a power electronics unit.

U.S. Pat. No. 6,278,196 describes an electric crankshaft machine operating as a generator, whereby the power electronics units is connected by means of a connector cable running through a connection piece (reference number 40 in FIG. 6).

It should be noted that the crankshaft machines in question are special electric machines since they are permanently dragged along by the combustion engine, and therefore have to handle a relatively high frequency and at the same time armatures with a relatively large diameter. Moreover, they are exposed to the heat conveyed by the combustion engine, as well as the vibrations and constant rotations of the combustion engine. Due to the continuous crankshaft and the little space available (usually only the regular space provided by the flywheel and the coupling, or—in the case of an engine with automatic transmission—the space occupied by the flex plate), the arrangement of the crankshaft machine creates special secondary requirements for the spatial design of the machine, i.e., it requires a disk-like construction (i.e., a short armature with a large diameter), whereby the machine is not accessible from the front.

Based upon these reasons, the crankshaft machines and related power electronics unit of the present application considerably differ from other electric machines, e.g., those for driving gears for electric vehicles, or stationary driving gears. The non-generic state of the art of said other machines has a series of suggestions for the relative arrangement and connection of electronics units and electric machines:

Conventional belt-driven vehicle generators are known from DE 197 15 925, which describes a rectifier unit with a cover protecting several electric components.

Electric drive units are known from DE 198 17 333 C1, which describes drives for electric vehicles, whereby the electric motor and an appertaining electronic module are electrically connected at the phase ends, for example, by means of internal connector lines. The electric motor and the electronic module are cooled by means of a common cooling circuit.

The above-mentioned article by B. Hoffman edited by Krappel, describes a cooling method for an electric crankshaft machine by means of the combustion engine's cooling water. The article further states the possibility of cooling the power electronics unit with the cooling water circuit of the combustion engine.

DE 196 05 037 A1 describes a drive, e.g., for pumps, ventilators and valves, presenting an alternate current asynchronous engine powered by a variable frequency converter, whereby a frequency converter, a control switch and a rotational angle sensor protecting against electromagnetic interference are either located in separate enclosures, or together with the asynchronous motor in one single enclosure.

Furthermore, an apparent stationary electric motor comprising a frequency converter is known from U.S. Pat. No. 5,714,816. Said motor is located in a removable electric motor enclosure. Conduits secure the electric connection between the enclosures. DE 197 14 784 A1 describes a compact drive with an electric motor, whereby the appertaining frequency converter is arranged on one face of the electric motor.

DE 196 26 213 A1 shows a drive motor for an electric vehicle comprising electronic components arranged at the front end plate, and cooled together with the electric motor.

DE 100 06 877 A 1 describes a drive system with a combustion engine and an electric machine operating like a generator or an engine, and provided with a power electronics unit. Said aggregates are cooled with a cooling system comprising two cooling circuits, whereby the first secures the cooling of the combustion engine and the electric machine, and the second the cooling of the power electronics unit.

DE 43 27 261 C1 describes a drive system with a fuel cell unit and an electric traction motor with appertaining power output unit. Said aggregates are cooled by means of two cooling circuits with different temperature levels, whereby one circuit cools the fuel cell unit, and the other cools the electric traction motor and the power output unit.

### SUMMARY OF THE INVENTION

Following a first aspect, the present invention is aimed at a motor vehicle drive system comprising, a combustion engine with a crankshaft, an electric machine designed as a starter, generator, or starter-generator and resting on the crankshaft of the combustion engine or an extension of the crankshaft, whereby said electric machine is a polyphase machine on the one hand, and a polyphase power electronics unit for the electric machine on the other hand. The power electronics unit is located at the combustion engine and both axially and radially offset to the electric machine. The electric machine and the power electronics unit are electrically connected by means of rigid electric conductors.

Following another aspect, the invention is aimed at a drive system of a motor vehicle comprising a combustion engine with a crankshaft, an electric machine, and a power electronics unit with a low-tension side to the electric machine. Said electric machine is designed as a starter, generator, or starter-generator and rests on the crankshaft of the combustion engine or an extension of the crankshaft. The electric machine presents a winding with coils connected with rotating power loops. The low-tension sides of the power electronics unit are rigidly electrically connected with the power loops.

Following yet another aspect, the invention is aimed at a drive system of a motor vehicle comprising the following: A combustion engine with a crankshaft; an electric machine designed as a starter or starter-generator resting on the crankshaft of the combustion engine or an extension of the combustion engine; and a power electronics unit for the electric machine. The combustion engine comprises mounting points and a mounting area fitted for connecting and arranging a conventional ring gear shift lever starter. The power electronics unit is affixed to said mounting points and arranged in said mounting area.

Other features are inherent in the disclosed products and methods or will become apparent to those skilled in the art from the following detailed description of embodiments and its accompanying drawings.

### BRIEF DESCRIPTION OF THE DRAWINGS

Embodiments of the invention will now be described, by way of example, and with reference to the accompanying drawings, in which:

FIG. 1 is a schematic view of a motor vehicle drive system with a combustion engine, an electric crankshaft machine, and an appertaining power electronics unit;

FIG. 2 is a schematic view of section II-II of FIG. 1;

FIG. 3 is an exploded view of a section of a power loop package layered in a radial direction;

FIG. 4 is an exploded view of a power loop package layered in an axial direction;

FIG. 5 is an exploded view of a section of a support fully equipped with a winding and power loops;

FIG. 6 is an exploded view of a section of a support comprising slots, in which winding structural parts have been lodged;

FIG. 7 is a schematic view of another possible arrangement of the power electronics unit;

FIG. 8 is a schematic view of yet other possible arrangements of the power electronics unit;

Some elements with the same or similar functions are indicated in the figures with the same reference.

### DETAILED DESCRIPTION OF THE INVENTION

Prior to explaining the figures in further detail, below are some remarks regarding to the embodiments:

The electric machine of certain embodiments is a polyphase machine, e.g., a three-phase machine designed as an asynchronous or, alternatively, a synchronous machine. The armatures of the electric machine rest on the crankshaft of the combustion engine or an extension of the combustion engine (for reasons of simplicity, the arrangement on a crankshaft extension will be no longer specifically mentioned; this option is included whenever an arrangement on the crankshaft and the designation of the machine as a “crankshaft machine” are mentioned). In certain embodiments, the armatures of the electric machine are connected torque proof with the crankshaft, which means that it permanently rotates at a constant frequency as those. Instead of having their own bearings, the armatures resting on the crankshaft of the electric machines of the shown embodiments are lodged above the crankshaft bearing. In other embodiments, the armature is concentrically mounted on the crankshaft and connected with the crankshaft by means of a planetary gear, and thus rotates at a larger or smaller frequency. In certain embodiments, the electric machine is designed as a combined starter-generator, i.e., as a motor-driven machine or generator-driven machine. In the case of motor-driven machine, the machine provides ample frequency and short-term power allowing to rev up and start the combustion engine from the support, if need be. In the case of a generator-driven machine, the machine provides ample electric power. The electric crankshaft machine of other embodiments is either designed only as a starter, or as a generator.

Even though it is, in principle, possible to mount the electric machine at the free end of the crankshaft, most embodiments prefer an arrangement whereby it rests on the crankshaft side connected with the drive branch, in particular between the combustion engine and the drive following in the drive branch, for example. The machine of said embodiments presents a disk-like construction and basically occupies the space reserved for the flywheel and the coupling in conventional drive systems, or—in case of an engine with automatic transmission—the flex plate. This arrangement does not allow the electric machine to be accessed from the front.

In certain embodiments, the power electronics unit is a current inverter comprising power semi-conductor switches and generating power impulses by means of the appropriate sinus-rated pulse-width modulation for the individual machine phases of the machine leading to sinusoid flows of (by approximation) the desired frequency, amplitude and phase based upon the low-pass effect of the inductance.

Different from the above-mentioned known drive system, certain embodiments of the electric machine and power electronics unit do not move relatively against one another. The power electronics unit of said embodiments is rather rigidly directly or indirectly connected with the electric machine, e.g., connected with the actual electric machine, or with a part of the drive system, such as the combustion engine or the drive, which do not move relatively to the electric machine. The electric connection of the power electronics unit and the electric machine is made possible by rigid electric conduits because of the non-relative moving arrangement. In several embodiments, the electric machine is arranged on the continuous crankshaft between the combustion engine and the drive system, whereas the power electronics unit is radially offset in an outward direction, i.e., radially arranged at the outside of the electric machine. Furthermore, the power electronics unit is axially offset to the electric machine. In most embodiments, the arrangement is axially offset in the direction of the combustion engine, whereas in other embodiments, it is axially offset in the direction of the drive system.

In several embodiments, the power electronics unit is mounted directly on the combustion engine, i.e., where a conventional ring gear shift lever starter would be arranged, for example. Clarification: Today's standard motor vehicles commonly use ring gear shift lever starters. The flywheel of the combustion engine comprises a toothed gear to be used as such. The starter generally comprises a mesh relay and a shift lever gear, enabling to shift the starter in the flywheel ring gear when starting the engine. The starter is generally mounted on the same end of the combustion engine as the flywheel, more specifically usually in such a way that the axle of the starter runs parallel with the outer perimeter of the flywheel, whereby the starter pinion meshes with the ring gear. Combustion engines are generally provided with mounting points, e.g., threaded holes on the flywheel end, for mounting said ring gear shift levers.

The embodiments with an electric crankshaft machine starter do not require conventional ring gear shift levers. This means that the starter no longer occupies the space provided in the motor housing of the combustion engine and the mounting points provided for mounting said ring gear shift levers. In several embodiments, the mounting space at the combustion engine commonly provided for housing the ring gear shift lever starter is now occupied by the power electronics unit for the crankshaft starter. Said power electronics unit is mounted on the mounting points provided for the ring gear shift lever starter. (It should be noted that, since there is no conventional ring loop shift lever starter, there is no ring gear either; for the rest, the armature of the electric crankshaft machine takes over the function of the flywheel by using the moment of inertia, thus making the flywheel redundant.)

In several of those embodiments, the outer dimensions of the power electronics unit mounted at the location where normally the ring gear shift lever starter is mounted, correspond more or less with the dimensions of a common ring gear shift lever starter, which means that the mounting space made available by the omitted starter is used by the power electronics unit, which therefore does not require any additional space. The outer dimensions of the power electronics unit are in a ratio of about 2 to 1 to 1 (L:W:H), whereby the length runs parallel with the crankshaft.

The mounting the power electronics unit at the same location where the conventional ring loop shift lever starter is mounted creates a special case of the above-mentioned axially and radially offset arrangement. In certain embodiments, the electric machine and the power electronics unit are also connected by means of rigid electric wiring in this special case. However, this is in no way mandatory; the electric connection of both units could also be done by means of flexible electric wiring such as bunched conductors.

The electric machine of certain embodiments comprises a winding having a number of phases and a corresponding number of branches. Each branch comprises a plurality of coils connected with rotating power loops, which run co-axially to the crankshaft. When each branch, for example, has a plurality of coils or coil groups connected in parallel, they are mounted along the perimeter of the power loops at regular intervals. In many embodiments, the number of power loops used equals the number of branches. Furthermore, in case of a star connection, an additional power loop could be provided connecting the branches (i.e., the so-called “star-point”). It is also possible, however, to use a star connection with a looped through connection of the individual coil ends without having to provide a separate power loop. Delta connections also do not require a power loop for the star point. In many embodiments, the power loops present connections, which are directly and rigidly connected with the low-tension sides of the power electronics unit. The connections are shaped like peg-like extensions of the power loops, for example, located askew at a distance from the rotational direction (e.g., radially outwards, or in an axial direction) of the power loops. In the case of a rigid connection between the power electronics unit and the power loops, the connection could be a removable connection, such as a plug-type connector, or a non-removable connection, such as a weld joint.

In some embodiments, the power electronics unit is arranged at the same level as the power loops. More exactly, the longitudinal axis of the power electronics unit (which runs approximately in the center through the power electronics unit in the direction of its longest side) is co-axially aligned with the crankshaft axis, whereby the distance between the longitudinal axis and the crankshaft axis corresponds approximately with the radius of the power loops. The rigid electric wires connecting the electric machine with the power electronics unit in said embodiments then run parallel with the crankshaft, for example, and run perpendicular against the power loops or the power loop connections.

In principle, it is possible to protect the rigid connector lines between the power electronics unit and the electric machine by means of a flexible cable, e.g., with a braided screen and/or a thin metal foil. The power electronics units of certain embodiments are provided with an enclosure extending to the electric machine and electromagnetically protecting the area of the electric connection of the power electronics unit and the electric machine. Besides this enclosure, the connector lines may also be protected with an additional cover such as a braided screen and/or a protective foil enclosing the rigid connector lines separately or jointly.

In view of the non-relative movable arrangement of the combustion engine, electric machine and power electronics units, certain embodiments comprise a cooling solution connecting both the power electronics unit and the electric machine with the cooling circuit of the combustion engine. The reverse stroke of the cooler of the combustion engine comprises a cooling circuit, for example, in which the power electronics units and the electric machine are connected in series. The serial connection is such that, for example, first the power electronics unit is arranged in the cooling circuit in the direction of the coolant flow. The electric machine is then arranged behind the power electronics unit. From a spatial perspective, the cooling circuit connection is constructed as follows: On the same side where the power electronics unit is electrically connected with the electric machine, it is also connected with a coolant line, which runs parallel, for example, with the rigid electric cable connections. Therefore, these embodiments provide for a material- and space-saving electric and cooling connection of the power electronics unit with the electric machine.

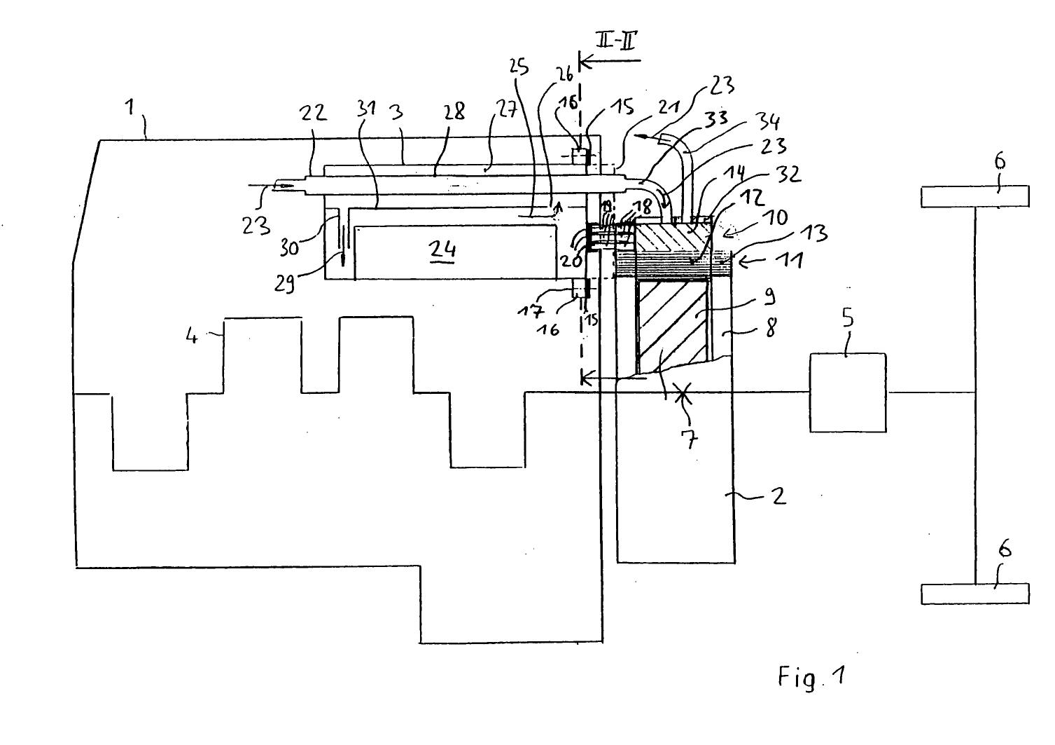

Returning to FIG. 1, it shows a schematic view of a motor vehicle drive system of a motor vehicle (not shown) with a combustion engine 1, an electric crankshaft machine 2 and an appertaining power electronics unit 3. The electric machine 2 and the power electronics unit 3 and the appertaining control unit are designed in such a way that the electric machine 2 can be operated as a motor in order to start the combustion engine 1 on the one side, and as a means to generate power while the combustion engine 1 is running, i.e., as a generator, on the other side. Therefore, it represents a combined starter-generator. In the case of an asynchronous machine, for example, the motor and generator operation differ by the fact that the magnetic rotary field rotates faster than the armature (positive slip) when the machine is operated as a motor, and slower than the armature (negative slip) when the machine is operated as a generator. This means that, in the first case, the electric power is supplied to the machine, where it is converted into mechanical power; in the latter case, the mechanical power is converted into electric power taken from the electric machine and supplied to an electric energy accumulator or consumer.

The combustion engine 1 presents a crankshaft 4, which is led out on one side (right in FIG. 1) and powers driving wheels 6 of the motor vehicle by means of a drive. The electric machine 2 is seated on the exiting part of the crankshaft 4 between the combustion engine 1 and the drive 5, and rests on a support 8 and an armature 9. The armature 9 is permanently torque proof connected with the crankshaft 4 (indicated in FIG. 1 with a cross symbol 7). In other embodiments (not shown), the armature is coupled with the crankshaft and can be removed (e.g., by means of an intermediate switch connection), or rotates at a higher or lower speed than the crankshaft (e.g., by means of an intermediate switch like a planetary drive).

FIG. 1 shows a partial cross-section of the electric machine 2, whereby the armature 9 and the interior structure of the support 8 are visible. The support 8 comprises a slotted support body 10 with a plurality of coils 11. In the cross-section of FIG. 1, the cutting plane runs through one of the slots of the support body 10, causing the slot conductors 12 to run in an axial direction visible in the cut-open slot. Connector lines 13 connect the slot conductor 12 in a slot of the coil 11 with other slot conductors 12 running in another slot of the coil 11. The connector lines 13 basically run in a tangential direction (in FIG. 1: Perpendicular to the paper level), more specifically in an axial direction on the exterior face sides of the support body 10. The support body 10 comprises a support back 14 arranged in a radial direction outside the slotted area and securing the return of the magnetic flow.

Since the combustion engine 1 is started with the electric machine 2 resting on the crankshaft 4 where the conventional flywheel is seated, the drive system of FIG. 1 does not require the conventional flywheel and the conventional ring gear shift lever that can be brought in mesh with the flywheel. This leaves the space normally reserved for the conventional starter available. Following FIG. 1, said space is occupied by the power electronics unit 3, as explained in further detail below.

The power switch unit 3 of some embodiments is a current inverter generating the appropriate frequency, amplitude and phase for the phase-alternate current by means of electronic switches (power semi-conductors) in order to operate the electric machine 2 in such a way that appropriate rotary fields powering the driving or breaking torque are created in the support 8 of the electric machine 2. A control fitted for the appropriate drive of the electronic switches may be integrated in the power electronics unit 3, for example, or may be located in a separate control device at a different location in the motor area.

The power electronics unit 3 of FIG. 1 arranged a conventional ring gear shift lever starter is oversized for reasons of clarity. In reality, it is only the same size at the most as the conventional ring gear shift lever starter provided for the individual combustion engine 1. It can be approx. 15 mm long, approx. 40 mm wide, and approx. 80 mm high, for example, thus meaning that it has a volume of less than one liter, which corresponds with a performance of approx. 1 kW for a conventional ring gear shift lever starter. The power electronics unit 3 weighs a little over 2 kg. The longitudinal axle, which runs approximately in the center in a longitudinal direction of the power electronics unit 3, runs parallel with the crankshaft axle, and is located approximately where the rotational axle would be located, more specifically where the pinions of the rotational axle would mesh with the conventional flywheel. The power electronics unit 3 is therefore arranged in an axially and radially offset direction relative to the electric machine. It is mounted to the combustion engine 1, and does therefore not move relative to the combustion engine 1 and the electric machine 2. The mounting is arranged with mounting points 15 provided at the combustion engine 1 for mounting a conventional ring gear shift lever starter. Smaller combustion engines generally have only two mounting points 15 at the side of the main drive pinion (see FIG. 1). Larger combustion engines have an additional mounting point for the opposite end of the conventional ring gear shift lever starter. The power electronics unit 3 not only has mounting points, but also complementary mounting flanges 16 with drill holes 17 connected with the mounting points by means of bolts, for example.

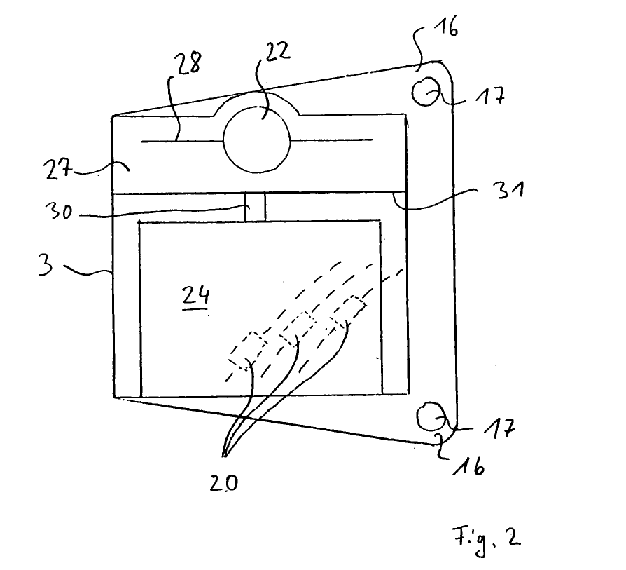

The support 8 comprises a number of power loops 18 (three, in this case) corresponding with the number of branches of the electric machine 2. Several coils 11 of the corresponding branch connected in parallel are connected with said power loops 18. The power loops 18 are rigid metal loops and could be composed of individual ring sectors for the purpose of saving material. They are arranged in a loop space which is radially located outside the connector lines 13 and axially in front of the support back 14 on the face of the electric machine 2 pointing at the combustion engine 1. The embodiment illustrated in FIG. 1 shows three radially layered power loops 18. The connection is dust-proof (e.g., welded) in an axial direction to the connection shanks 19 away from the power electronics unit 3. Said connection shanks 19 are arranged in an offset pattern in the circumferential direction of the power loops 15 (FIG. 2). The connection shanks 16 create rigid electric wires directly connecting the electric machine 2 with the power electronics unit 3. In the embodiment of FIGS. 1 and 2, the connection comprises connection shoes 20 plugged onto the connection flanges 19. An alternative for this plug-like connection could consist of other removable connection types, such as screws or clamping joints, or non-removable connections such as welded or solder joints. A reversed construction is also possible, of course, whereby the power armatures (as the equivalent of the connection flanges) are led out of the interior of the power electronics unit 3 and directly connected, e.g., welded, to the power loops 18.

In embodiments in which the electric machine 2 does not have power loops, but the line ends of the branches are rather led out of the support, the nearly rigid copper lines may be directly connected with the power electronics unit 3. The connection shoes 20 could then be replaced with another suitable connection between the lines and the low tension side of the power electronics unit, e.g. by screwing concentration rings for the branch ends to the low tension side of the power electronics unit.

The power electronics unit 3 presents an enclosure 21 (illustrated in FIG. 1 with a dashed line) made of a conductive material reaching from the power electronics unit 3 to the electric machine 2, where it encloses the area of the electric connection between the power electronics unit 3, i.e., the connection shoes 20, and the part of the connection flanges 19 protruding from the electric machine 1, thus creating an electromagnetic shield for said area.

As illustrated in FIGS. 1 and 2, the power electronics unit 3 and the electric machine 2 are jointly cooled by means of a coolant flow 22. This flow belongs to a cooling circuit (not shown) of the combustion engine 2. More specifically, the power electronics unit 3 and the electric machine 2 are consecutively connected in series in the coolant flow 22. This serial connection is arranged parallel to the combustion engine in the cooling circuit. The coolant flow 22 is arranged in the reverse movement of the cooler of the combustion engine, for example, in such a way that the temperature of the coolant is as low as possible when entering the power electronics unit 3. The coolant flow 22 is sidetracked to the cooler of the combustion engine away from the cooling circuit of the combustion engine, and flows first through the power electronics unit 3, and subsequently through the post 8 of the electric machine 2 (indicated in FIG. 1 with arrows 23). Thanks to this arrangement, the power electronics unit 3 has a lower temperature level than the (less heat-sensitive) electrical machine 2.

The actual cooling of the different heat sources 23 in the power electronics unit 3—which are mainly power semi-conductors, but also capacitors and current conductors—is done by means of evaporative cooling, which works as follows: The interior of the power electronics unit 3 is hermetically sealed and filled with an evaporative means such as a fluorocarbon, whereby the pressure in the interior is set as to have the evaporating point of the evaporating means at the desired cooling temperature, i.e., at a return temperature of the combustion engine coolant of 1050C at 120° C. If a heat source 24 exceeds the evaporating temperature, the evaporating means will evaporate at the site of the heat source 24 in such a way that its temperature cannot exceed the evaporating temperature because the evaporating heat has been removed. The steam of the evaporating means, symbolized by arrow 25 in FIG. 1, travels through an opening 26 in a condensing chamber 27 arranged above the heat sources 24, where it condenses at a heat exchanger 28 thermally linked with the coolant flow 22 whilst releasing the condensing heat. The condensed evaporating liquid then flows back through a duct 30 (symbolized with an arrow 29) to the bottom of the interior of the power electronics unit 3. Besides the openings 26 and 30, the condensing chamber 27 is also separated by a partition 31 from the space to be cooled which containing the heat sources 24. Other embodiments (not shown) are not equipped with such a partition; the steam of the evaporating means directly raises to the heat exchanger 26, and the condensate immediately return from there to the level of the evaporating means.

The support 8 of the electric machine 2 comprises a cooling coat 32 circulating at the outer perimeter of the support 8. The coolant of the coolant flow 22 travels through a rigid connector line 33 coming from the power electronics unit 3, and enters the cooling coat 32 at a point at the outside perimeter; subsequently, it flows once around the support 8 and leaves the electric machine 2 through a return line 34 located near the entrance, after which it goes back to the combustion engine circuit. In order to avoid a short-circuit, the cooling coat 32 is interrupted between the connector line 33 and the return line 34 in a circumferential direction. The armature 9 only receives indirect cooling from the surrounding support 8 by means of heat radiation and convection. This is adequate for typical applications, however.

In many embodiments, the plurality of power loops 18 is connected into one single insulating power loop, e.g., by gluing them with insulating intermediate coats. This way, they create one single component, which allows for simplified mounting to and connection with the support 8. The power loop package 35 fills the free space on the face of the support body 10 in a radial direction outside the connection line 13, and in an axial direction in front of the post back 14. This means that the power loops 18 use a space, which is not usable otherwise and lies in close proximity to the coil ends on the one side, and the power electronics unit 3 on the other side.

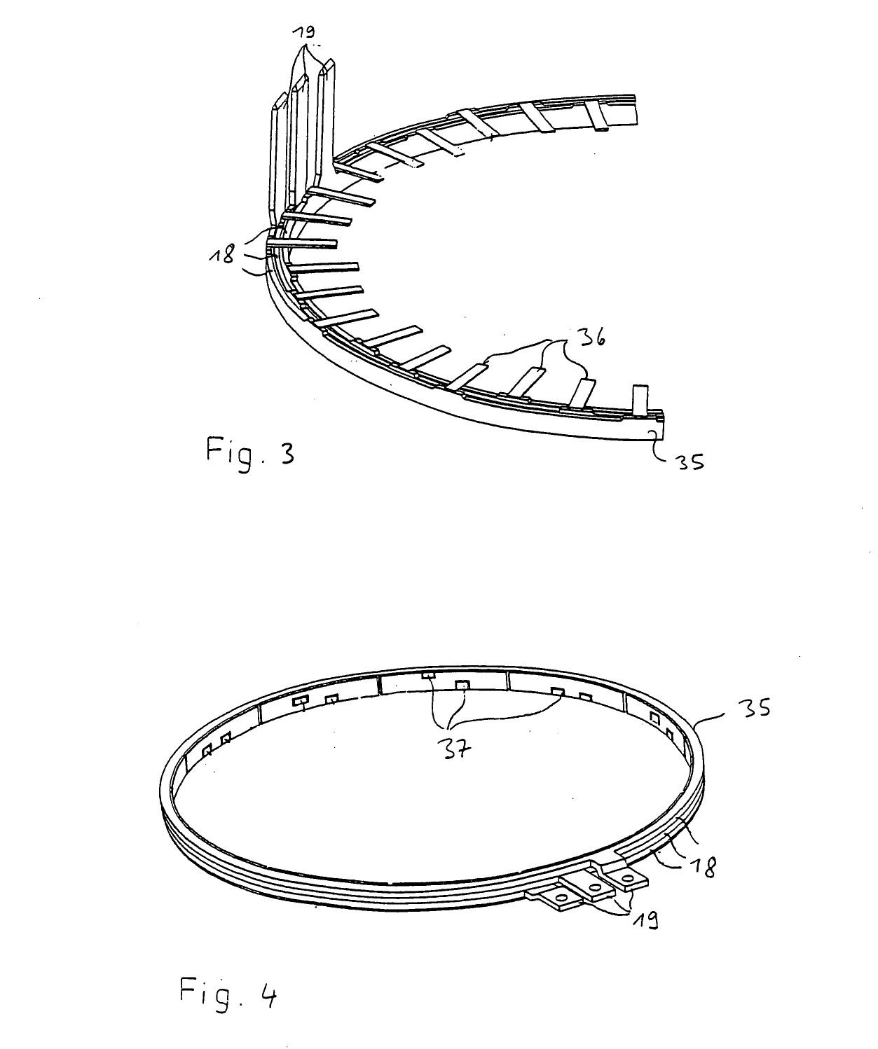

The power loops 18 may be layered in the power loop package 35 in a radial or—alternatively—axial direction (relative to the rotating axle of the electric machine 2). FIG. 3 shows a detailed view of the radial layering pattern shown already in FIG. 1. FIG. 4 shows an alternative embodiment with an axial layering pattern. The radially layered power loop package 35 comprises mounting straps 36 to connect the individual coils. Said mounting straps 36 point radially inward and are axially offset outward at the level of the power loop package in such a way that they travel along the interior and, if provided, center power loop 18 without contacting it—for as far as they are connected with the center or outer power loop 18. On the other side, all power loops 18 of the axially layered power loop package 35 shown in FIG. 4 are directly accessible from the inside, which means that they do not need to be directed in an axial direction. When the power loop package 35 comprises an insulating coat or comprises line sections creating the so-called star-point line (as shown in FIG. 4) after being superposed with coil ends, the connection of the coil ends with the corresponding power loops 18 comprises contact windows 37 distributed along the circumference at difference axial locations corresponding with the location of the power loop 18 to be contacted in the power loop package 35. On the other side, the radially layered power loop package 35 makes it easier to connect the power electronics unit 3 than an axially layered power loop package 35. In the embodiment with a radially layered power loop package 35 of FIG. 3, the connection shanks 19 stick out in an axial direction from the individual power loops 18; these already represent the rigid connector lines of the power electronics unit 3, where they are plugged directly into the connection shoes 20, for example. Because of the radial layering pattern of the power loops 18, it is basically possible to arrange the connection flanges 19 on top of each other without adding an insulating layer. The example shown in FIG. 3 does not use this option. Instead, the connection flanges 19 of the individual branches are offset in a circumferential direction. This is reflected by a complementary arrangement offset accordingly from the connection 20 at the power electronics unit (see FIG. 2). In the case of the axially layered power loop package 35 of FIG. 4, the connection of the center and back power loops 18 (seen from the power electronics unit 3) is directed along the front and possibly center power loop 18, similar to connection flanges 36 of the radially layered power loop package 35 of FIG. 3. Following FIG. 4, said connections are directed by first directing the connection flanges 19 radially outward, and finally extending them in a square deviation in the direction of the power electronics unit 3. FIG. 4 only shows the part of the connection flanges 19 which is directed radially outward; radial connection lines squarely arranged to the power electronics unit 3 are, for example, screwed or welded to said power electronics unit 3. In other embodiments, the connection flanges, which are first deviated in a radially outward, and then in an axial direction, are formed in one piece (e.g., bent). In the axially layered embodiment, the offset of the connection flanges 19 shown in FIG. 4 is advantageous in the direction of the perimeter since it allows the connection lines running in an axial direction to be arranged offset in the direction of the perimeter.

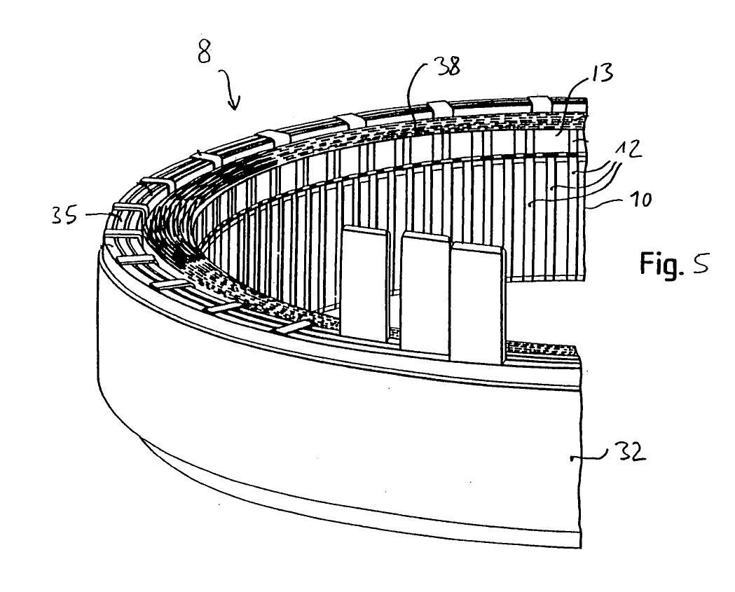

FIG. 5 shows the support 8 fully equipped with the power loop package 35 of FIG. 3 and a winding. The innermost slot lines 12 are visible in the slots of the support body 10. The connection lines 13 connecting the slot lines 12 of a coil create a compact rotating connector line package 38 on both front sides of the support 8. The above described power loop package 35 of FIG. 3 is radially arranged outside the connector line package 38. The connection flanges 36 (stretched out in FIG. 3) are bent inwards between the connector line package 38 and the power loop package 35, and then connected each time with a coil end.

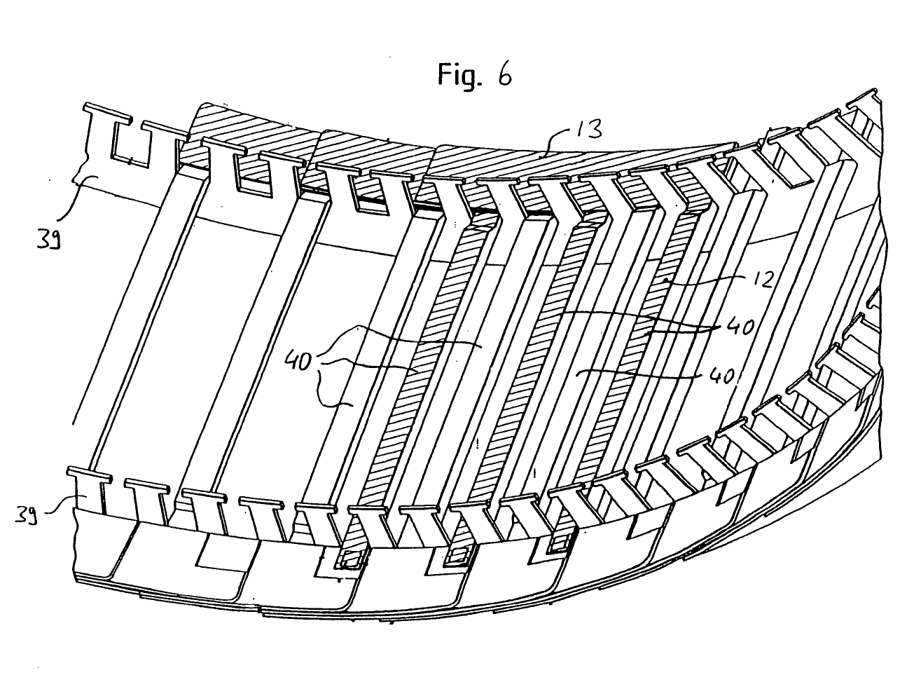

In certain embodiments, the winding of certain embodiments is not coiled up of one coherent wire (even though this option is herein incorporated by reference), but rather composed of a plurality of individual preformed structural parts. These structural parts are arranged in the slots and electrically connected, e.g., welded, to connection points with other similar structural parts. For reasons of pictorialization of such a structural part winding, FIG. 6 only shows both exterior front sides 39 of the support body 10. Said support body 10 is typically made of a stack of electric sheets layered in an axial direction. Therefore, the front sides 39 illustrated in FIG. 6 each correspond with the outer sheet of the sheet package. FIG. 6 shows the support 8 under construction, having only part of the first layer of winding structural parts 40 arranged in the support body 10. The structural parts 40 are L-shaped. A coherent coil 11 is created as follows: A connection is made connecting each side of the “L” with the neighboring L-shaped structural part 40, whereby one neighboring part creates an underlying semi-winding, and the other neighboring part creates a semi-winding on top of it. The individual coils overlap each other in such a way that connection lines 13 of different coils 11 run in the connection line package 38. Said overlapping coils 11 are arranged in layers, i.e., a structural part layer is consecutively placed in the slots for the entire support 8, and welded to structural parts 40 provided earlier, after which the next layer is placed and welded. The coil beginnings are not welded to the other structural parts 40, but are rather welded to another mounting strap 36 in order to connect them with the power loops 18. In several embodiments, two neighboring coils 11 are connected in series, whereby the winding in the first coil 11 moves radially inward, and the winding in the second coil 11 moves radially outward; both coils are internally radially connected. Publication PCT/EP01/06272 mentioned at the beginning of the present application describes such a winding and power loop arrangement for an electric crankshaft machine and is herein incorporated by reference.

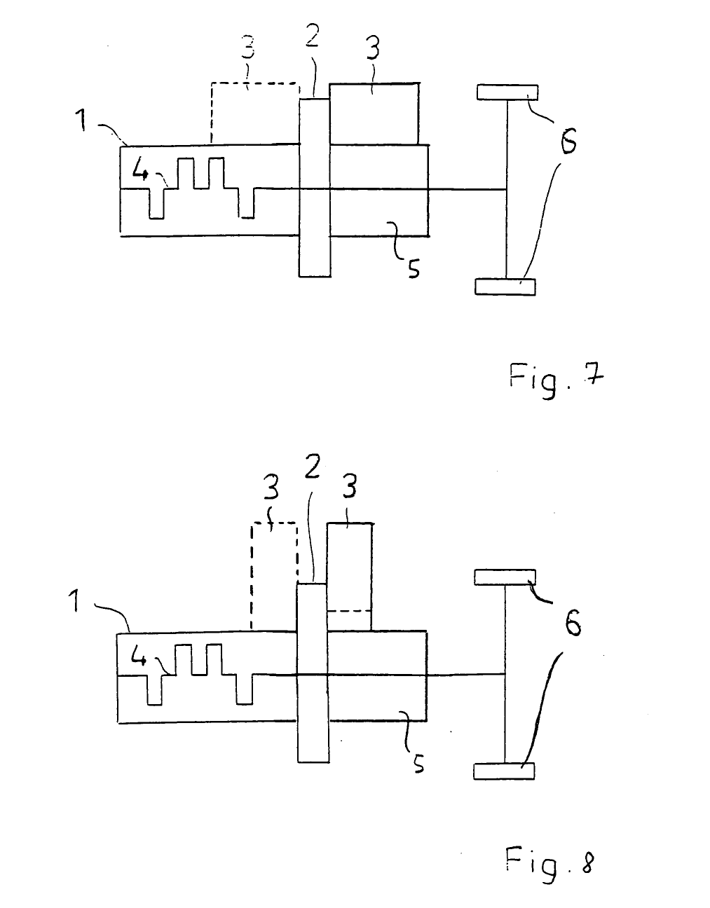

Finally, FIGS. 7 and 8 show schematic views of other possible embodiments, whereby the power electronics unit 3 is offset in an axial and radial direction to the electric machine 2. In this case, the power electronics unit 3 is not arranged at the same location as a conventional ring gear shift lever starter. FIG. 7 not only shows the above-mentioned special mounting location at the ring gear shift lever starter (indicated with a dashed line), but also an arrangement on the drive side (marked with solid lines), whereby the power electronics unit 3 is mounted to the drive 5. FIG. 8 shows yet other embodiment, whereby the longitudinal axle of the power electronics unit 3 is located square to the axle of the crankshaft. In turn, it can be mounted yet again on the drive 5 (solid line in FIG. 8) or, alternatively, at the combustion engine 2 (dashed line in FIG. 8).

In the embodiments, the cables normally provided for the connection between the power electronics unit and the electric machine are dropped in the embodiments. This not only allows for structural simplification and material savings, but also for the creation of a relatively low-inductive connection with good electromagnetic tolerance. Moreover, the connection of said embodiments is relatively short, which means that the required line diameters can be considerably reduced whilst maintaining the same total line resistance. The arrangement of the power electronics unit at the location of the conventional ring gear shift lever starter makes it possible to install a crankshaft starter in existing conventional vehicle assemblies, without requiring any major modification of the engine space assembly. The arrangement also makes it possible to provide a simple cooling means for the unit of the electric crankshaft machine and the appertaining power electronics unit by connecting them both with the cooling circuit of the combustion engine.

All publications and existing systems mentioned in this specification are herein incorporated by reference.

Although certain products constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalence.

What is claimed:

1. Drive system for a motor vehicle, comprising:
a combustion engine with a crankshaft;
an electric machine designed as a starter, generator, or starter-generator, and seated on the crankshaft of the combustion engine or an extension of the crankshaft, wherein the electric machine is a polyphase machine;
a polyphase power electronics unit for the electric machine;
wherein the power electronics unit is located at the combustion engine in a radially and axially offset direction to the electric machine; and
wherein the electric machine and the power electronics unit are electrically connected by means of rigid electric conductors.

2. The drive system of claim 1, wherein:
the combustion engine presents mounting points suitable for mounting a conventional ring gear shift lever starter; and
wherein the power electronics unit is mounted on the mounting points.

3. The drive system of claim 1, wherein the exterior dimensions of the power electronics unit are approximately 2 to 1 to 1 (L:W:H).

4. The drive system of claim 1, wherein the electric machine comprises a polyphase winding with coils, wherein said coils are connected with rotating power loops, and wherein said power loops comprise connections, which are directly and rigidly connected with low tension sides of the power electronics unit.

5. The drive system of claim 4, wherein the connections are designed as shank-like extensions of the power loops, and are at a distance and in a square deviation in the rotational direction of the power loops.

6. The drive system of claim 4, wherein the power electronics unit comprises a longitudinal axle, and the power loops present a radius, and the longitudinal axle is co-axially aligned with the crankshaft axle, and the distance between said longitudinal axle and the crankshaft axle corresponds approximately with the radius of the power loops.

7. The drive system of claim 4, wherein the rigid electric connections connecting the electric machine and the power electronics unit run co-axially to the crankshaft axle and perpendicular against the power loops or the power loop connections.

8. The drive system of claim 1, wherein the power electronics unit comprises an enclosure providing electromagnetic shielding between the area of the electric connections and the electric machine.

9. The drive system of claim 1, comprising a coolant circuit cooling the combustion engine, and wherein the power electronics unit and the electric machine are connected with the cooling circuit of the combustion engine for cooling purposes.

10. The drive system of claim 9, wherein the power electronics unit and the electric machine are connected in series in the cooling circuit.

11. The drive system of claim 10, wherein a flow direction of the coolant means is indicated in the cooling circuit, and wherein the power electronics unit is placed first and followed by the electric machine in the connection in series of the power electronics unit and the electric machine.

12. Drive system of a motor vehicle, comprising:
a combustion engine with a crankshaft;
an electric machine designed as a starter, generator, or starter-generator, and seated on the crankshaft of the combustion engine or an extension of the crankshaft, wherein the electric machine presents a winding with coils connected with the rotating power loops;
a power electronics unit with low tension sides to the electric machine; and
wherein the low tension sides of the power electronics unit are electrically connected with the power loops by means of rigid electric conductors.

13. The drive system of claim 12, wherein:
the combustion engine presents mounting points suitable for mounting a conventional ring gear shift lever starter; and
wherein the power electronics unit is mounted to the mounted points.

14. The drive system of claim 12, wherein the exterior dimensions of the power electronics unit are in a ratio of 2 to 1 to 1 (L:W:H).

15. The drive system of claim 12, wherein the power loops provided for the connection of the conductor lines to the power electronics unit comprise shank-like extensions extending in a square deviation in the rotational direction of the power loops.

16. The drive system of claim 12, wherein the power electronics unit presents a longitudinal axle and the power loops a radius, and wherein said longitudinal axle is arranged co-axially to the crankshaft axle, and the distance between the longitudinal axle and the crankshaft axle corresponds approximately with the radius of the power loops.

17. The drive system of claim 12, wherein the electric machine and the power electronics unit are connected by means of rigid electric lines running co-axially to the crankshaft axle and perpendicular against the power loops or the power loop connections.

18. The drive system of claim 12, comprising a cooling circuit for cooling the combustion engine, and wherein the power electronics unit and the electric machine are connected with the cooling circuit of the combustion engine for the purpose of cooling.

19. Drive system of a motor vehicle, comprising:
a combustion engine with a crankshaft, wherein the combustion engine presents mounting points and a mounting area suitable for mounting and arranging a conventional ring gear shift lever starter;
an electric machine designed as a starter, or starter-generator, and seated on the crankshaft of the combustion engine or an extension of the combustion engine;
a power electronics for the electric machine;
wherein the power electronics unit is mounted to said mounting points and arranged in said mounting area.

20. The drive system of claim 19, wherein the exterior dimensions of the power electronics unit are in a ratio of 2 to 1 to 1 (L:W:H).

21. The drive system of claim 19, wherein the electric machine and the power electronics unit are electrically connected by means of rigid electric lines.

22. The drive system of claim 21, wherein the electric machine comprises a polyphase winding having coils connected to the rotating power loops and rigidly connected with the low-tension sides of the power electronics unit.

23. The drive system of claim 22, wherein the power loops present shank-like extensions for the purpose of connecting the connection lines with the power electronics unit, and wherein said extension extends squarely to the rotational direction of the power loops.

24. The drive system of claim 22, wherein the power electronics unit presents a longitudinal axle and the power loops a radius, and wherein said longitudinal axle is arranged co-axially to the crankshaft, and the distance between said longitudinal axle and the crankshaft axle corresponds approximately with the radius of the power loops.

25. The drive system of claim 22, wherein the electric machine and the power electronics unit are connected by means of rigid electric lines running co-axially to the crankshaft axle and perpendicular against the power loops or the extensions of the power loops.

26. The drive system of claim 19, comprising a cooling circuit for cooling the combustion engine, and wherein the power electronics unit and the electric machine are connected with the cooling circuit of the combustion engine for the purpose of cooling.
